(19) United States
(12) Patent Application Publication
(10) Pub. No.: US 2010/0194102 A1
(43) Pub. Date: Aug. 5, 2010

(54) PUSH-IN ADAPTOR

(75) Inventor: Lee John Keeling, West Midlands (GB)

Correspondence Address: The Ollila Law Group LLC, 2569 Park Lane, SUITE 202, Lafayette, CO, 80026, US

(73) Assignee: Norgren Limited, Staffordshire (GB)

(21) Appl. No.: 12/667,897

(22) PCT Filed: Jul. 21, 2008
(86) PCT No.: PCT/GB08/02510

§ 371 Date: Jan. 6, 2010

(30) Foreign Application Priority Data
Jul. 19, 2007 (GB) 0714017.1

(51) Int. Cl. F16L 37/091

(52) U.S. Cl. 285/305

(57) ABSTRACT

A push-in adaptor (1) includes an adaptor body (3) including a first end (81) and a second end (82) and a bore (7) passing fully through the body (3) and a first push-in retention mechanism (91) located on the first end (81). The first end (81) is adapted to push in to a first pneumatic or hydraulic component. The push-in adaptor (1) further includes a second push-in retention mechanism (92) located on the second end (82). The second end (82) is adapted to push in to a second pneumatic or hydraulic component.

### BACKGROUND OF THE INVENTION

1. Field of the Invention

The present invention relates to a push-in adaptor, and more particularly, to a push-in adaptor including push-in mechanisms at both ends of the push-in adaptor.

2. Statement of the Problem

Pneumatic and hydraulic systems use pressurized gas or pressurized fluid to perform mechanical work. Consequently, such systems require networks of conduits and/or hoses and accompanying fittings. One such fitting is an adaptor that couples a first pneumatic or hydraulic component to a second pneumatic or hydraulic component.

An adaptor can be used in a pneumatic or hydraulic system for a variety of reasons. An adaptor can join flexible hoses to rigid conduits. An adaptor can join together components of different sizes or types. An adaptor can provide ease of assembly, such as a push-in fitting that enables efficient construction.

FIG. 1 shows a prior art screw-in brass adaptor 100. The prior art screw-in brass adaptor 100 comprising a substantially tubular body 101 formed of brass. The body 101 includes a first end 102 and a second end 103. The first end 102 engages with a push-in fitting 104 of a first component and the second end 103 comprises a threaded portion 105. The first component can comprise any manner of pneumatic or hydraulic component, such as a coupling (shown). The threaded portion 105 is adapted to be screwed into engagement with a threaded bore (not shown) in a second component. The threaded engagement is a standard apparatus for joining components and is strong and is generally leak-proof.

The prior art screw-in brass adaptor 100 has drawbacks. Brass is relatively heavy and can add significant mass to a system. The prior art screw-in brass adaptor 100 is expensive to produce, as brass is a costly material. Further, the machining of threads into brass is a costly and time-consuming manufacturing process. Tools are required for the assembly of the prior art screw-in brass adaptor 100 and a corresponding component. Moreover, the threaded portion 105 may not form an adequate seal and further seals or sealing material may be required in order to achieve a leak-proof junction. Threaded connections can vibrate apart and result in leakage or disconnection over time.

### ASPECTS OF THE INVENTION

In one aspect of the invention, a push-in adaptor is provided. The push-in adaptor comprises:

an adaptor body including a first end and a second end and a bore passing fully through the body;

a first push-in retention mechanism located on the first end, wherein the first end is adapted to push in to a first pneumatic or hydraulic component; and

a second push-in retention mechanism located on the second end, wherein the second end is adapted to push in to a second pneumatic or hydraulic component.

Preferably, the body is formed of a metallic material.

Preferably, the body is formed of a non-metallic material.

Preferably, the body is formed of a lightweight material.

Preferably, the body is formed of a plastic material.

Preferably, the first push-in retention mechanism further comprises a second groove formed circumferentially on an outer surface of the adaptor body at the first end, a securing element engaged with the second groove and configured to engage an apparatus bore, and a first gripping element trapped between the securing element and a circumferential shoulder formed on the outer surface of the adaptor body, wherein the first gripping element is configured to engage and retain the push-in adaptor in the apparatus bore.

Preferably, the first push-in retention mechanism further comprises a first groove formed circumferentially on an outer surface of the adaptor body at the first end, a first seal configured to fit partially in the first groove and adapted to sealingly contact the apparatus bore, a third groove formed circumferentially on an outer surface of the adaptor body at the first end, and a third seal configured to fit partially in the third groove and adapted to sealingly contact the apparatus bore.

Preferably, the first gripping element further comprises an annular member that substantially sealingly fits to the outer surface of the adaptor body and a plurality of gripping teeth extending substantially radially outwardly from the annular member.

Preferably, the plurality of gripping teeth is substantially inclined toward the annular member.

Preferably, the second push-in retention mechanism further comprises a substantially conical surface formed on the outer surface of the adaptor body at the second end, a circumferential shoulder located on the second end adjacent to the substantially conical surface, wherein the circumferential shoulder is configured to retain the clip on the substantially conical surface, a clip positioned on the substantially conical surface, wherein the clip engages the second end of the adaptor body, and a second gripping element configured to be held between a step portion of the substantially conical surface and the clip, with the second gripping element abutting a step portion substantially opposite the circumferential shoulder across the substantially conical surface.

Preferably, the second gripping element further comprises an annular member that substantially sealingly fits to the outer surface of the adaptor body and a plurality of gripping teeth extending substantially radially outwardly from the annular member.

Preferably, the plurality of gripping teeth is substantially inclined toward the annular member.

Preferably, the clip further comprises a head portion and a plurality of securing legs that extend substantially axially from the head portion.

Preferably, the second gripping element further comprises a seal located on a reduced diameter port of the second end.

Preferably, the push-in adaptor further comprises a collar including an annular recess, with the collar being adapted to fit over and engage a seal of the second component.

In one aspect of the invention, a push-in adaptor is provided. The push-in adaptor comprises:

an adaptor body including a first end and a second end and a bore passing fully through the body;

a second groove formed circumferentially on an outer surface of the adaptor body at the first end;

a securing element engaged with the second groove and configured to engage an apparatus bore; and

a first gripping element trapped between the securing element and a circumferential shoulder formed on the outer surface of the adaptor body, wherein the first gripping element is configured to engage and retain the push-in adaptor in the apparatus bore.

Preferably, the body is formed of a metallic material.

Preferably, the body is formed of a non-metallic material.

Preferably, the body is formed of a lightweight material.

Preferably, the body is formed of a plastic material.

Preferably, the push-in adaptor further comprises a first groove formed circumferentially on an outer surface of the adaptor body at the first end, a first seal configured to fit partially in the first groove and adapted to sealingly contact the apparatus bore, a third groove formed circumferentially on an outer surface of the adaptor body at the first end, and a third seal configured to fit partially in the third groove and adapted to sealingly contact the apparatus bore.

Preferably, the first gripping element further comprises an annular member that substantially sealingly fits to the outer surface of the adaptor body and a plurality of gripping teeth extending substantially radially outwardly from the annular member.

Preferably, the plurality of gripping teeth is substantially inclined toward the annular member.

In one aspect of the invention, a push-in adaptor is provided. The push-in adaptor comprises:

an adaptor body including a first end and a second end and a bore passing fully through the body;

a substantially conical surface formed on the outer surface of the adaptor body at the second end;

a circumferential shoulder located on the second end adjacent to the substantially conical surface, wherein the circumferential shoulder is configured to retain the clip on the substantially conical surface;

a clip positioned on the substantially conical surface, wherein the clip engages the second end of the adaptor body; and

a second gripping element configured to be held between a step portion of the substantially conical surface and the clip, with the second gripping element abutting a step portion substantially opposite the circumferential shoulder across the substantially conical surface.

Preferably, the body is formed of a metallic material.

Preferably, the body is formed of a non-metallic material.

Preferably, the body is formed of a lightweight material.

Preferably, the body is formed of a plastic material.

Preferably, the second gripping element further comprises an annular member that substantially sealingly fits to the outer surface of the adaptor body and a plurality of gripping teeth extending substantially radially outwardly from the annular member.

Preferably, the plurality of gripping teeth is substantially inclined toward the annular member.

Preferably, the clip further comprises a head portion and a plurality of securing legs that extend substantially axially from the head portion.

Preferably, the push-in adaptor further comprises a seal located on a reduced diameter port of the second end.

Preferably, the push-in adaptor further comprises a collar including an annular recess, with the collar being adapted to fit over and engage a seal of the second component.

### DESCRIPTION OF THE DRAWINGS

The same reference number represents the same element on all drawings. It should be understood that the drawings are not necessarily to scale.

FIG. 1 shows a prior art screw-in brass adaptor.

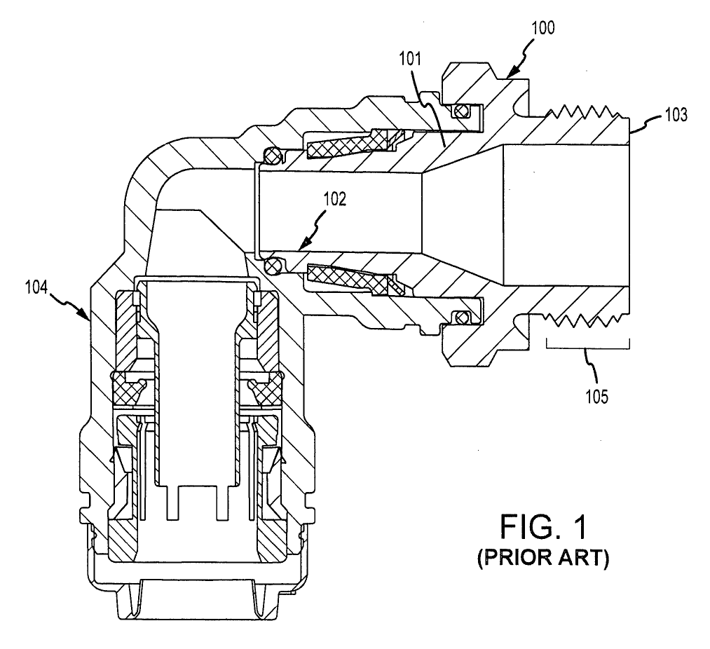

FIG. 2 shows a portion of a push-in adaptor according to an embodiment of the invention.

FIG. 3 shows the push-in adaptor ready for use according to an embodiment of the invention.

FIGS. 4A-4B show detail of the first gripping element according to an embodiment of the invention.

FIGS. 5A-5B show detail of the second gripping element according to an embodiment of the invention.

FIG. 6 shows the push-in adaptor mated to a first pneumatic or hydraulic component according to an embodiment of the invention.

FIG. 7 shows the push-in adaptor mated to a second pneumatic or hydraulic component according to an embodiment of the invention.

### DETAILED DESCRIPTION OF THE INVENTION

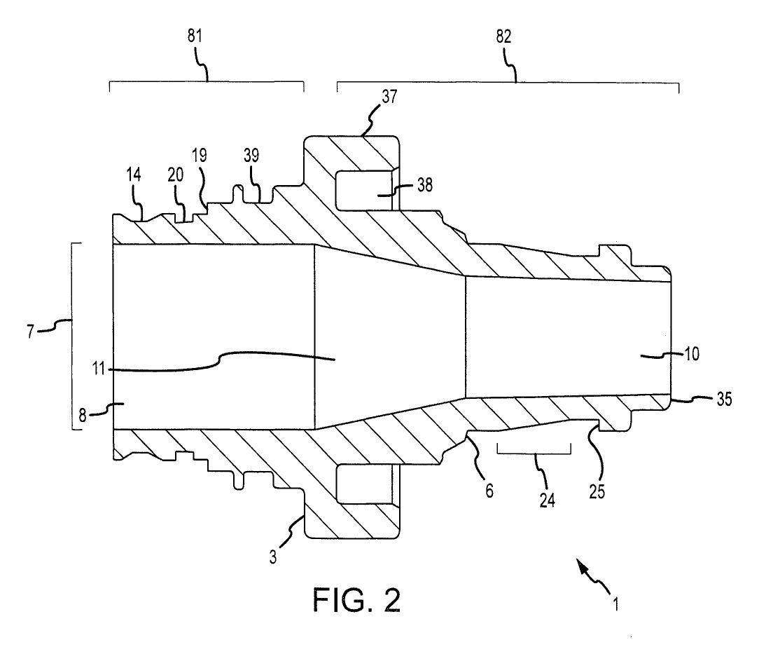

FIGS. 2-7 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

FIG. 2 shows a portion of a push-in adaptor 1 according to an embodiment of the invention. The push-in adaptor 1 is not fully configured for use in this figure. The push-in adaptor 1 includes a body 3 including a first end 81 and a second end 82 and a bore 7 that passes fully through the body 3. A first push-in retention mechanism 91 is located on the first end 81 and a second push-in retention mechanism 92 is located on the second end 82. Employing both the first push-in retention mechanism 91 and the second push-in retention mechanism 92, the push-in adaptor 1 can be quickly installed by hand in a first pneumatic or hydraulic component and in a second pneumatic or hydraulic component.

The push-in adaptor 1 has particular application in pneumatic and hydraulic systems, although, for simplicity, this description hereinafter will focus on pneumatic systems. It is common for pneumatic systems to be connected together by pneumatic lines that typically comprise hoses, such as rubber or reinforced rubber hoses, for example. This enables the transfer of pneumatic pressure from a source to a destination or between various apparatus for power and/or control purposes.

The push-in adaptor 1 may fit into a further apparatus that may comprise a valve, valve island, pressure generating means, fluid-operated tool, industrial robot or control unit, for example. Other devices are contemplated and are within the scope of the description and claims.

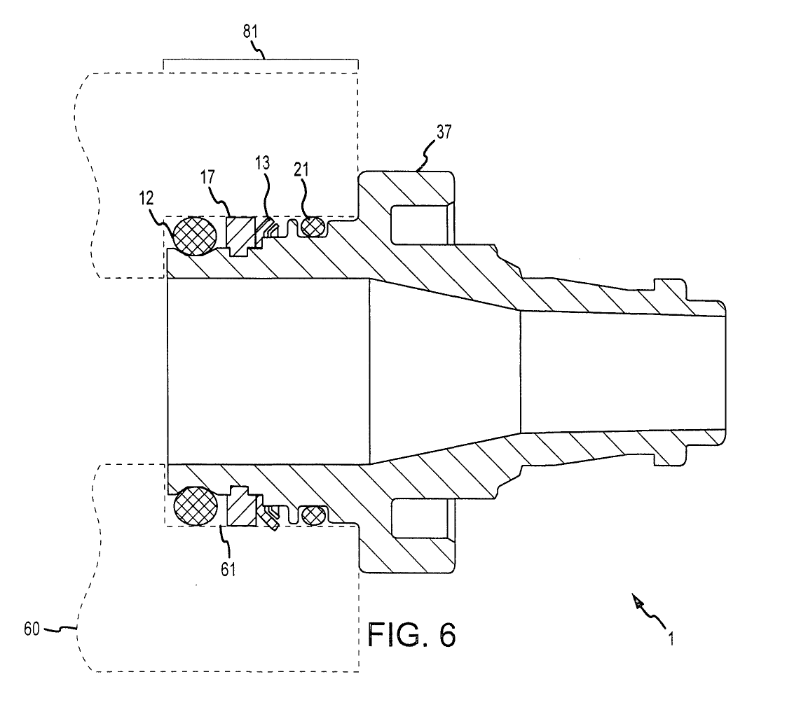

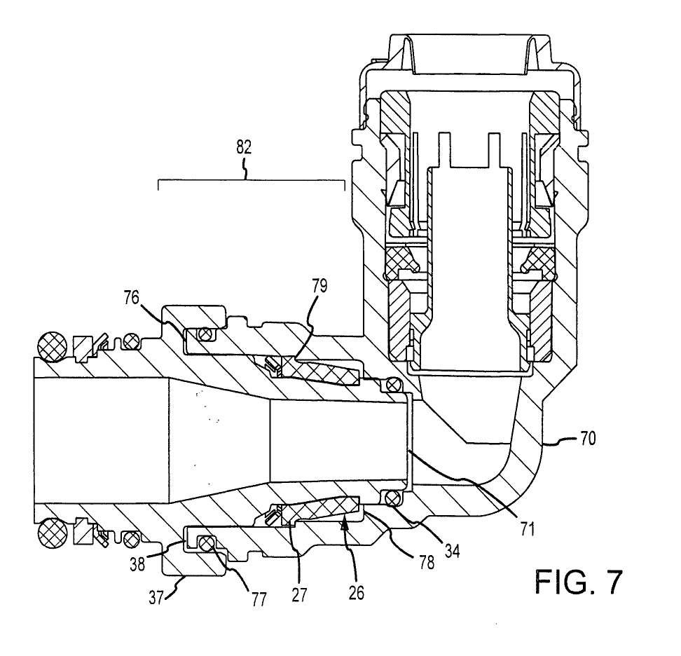

The first end 81 and the second end 82 are configured to be positioned within and sealingly mate with a first pneumatic or hydraulic component 60 and a second pneumatic or hydraulic component 70 (see FIGS. 6 and 7). The first end 81 and the second end 82 are configured to push into a first component bore 61 in the first component 60 and a second component bore 71 in the second component 70. The first and second component bores 61 and 71 can be substantially smooth and regular and can comprise drilled or machined bores, for example. However, the first and second component bores 61 and 71 do not require any special features for mating and therefore do not require a high level of smoothness or uniformity. For example, the first and second component bores 61 and 71 can be cast, molded, or otherwise formed in the first and second components 60 and 70 during forming of the body 3.

The bore 7 can be of any predetermined shape and size, as dictated by the dimensions of the body 3. The bore 7 can comprise a substantially uniform bore, if desired. Alternatively, the bore 7 can be non-uniform, as shown, including a larger diameter portion 8, a smaller diameter portion 10, and a tapering portion 11 that communicates between the larger diameter portion 8 and the smaller diameter portion 10. The larger diameter portion 8 and the tapering portion 11 of the bore 7 are formed within a larger body portion of the adaptor body 3 while the smaller diameter bore portion 10 is formed within a smaller body portion.

The first end 81 includes a first groove 14, a second groove 20, a circumferential shoulder 19, and a third groove 39. It should be understood that the three grooves and the shoulder comprise one embodiment, and the number and placement of grooves and shoulders can be varied as needed.

The second end 82 includes a circumferential shoulder 25, a substantially conical surface 24, a step portion 6, and a collar 37 including a substantially annular recess 38.

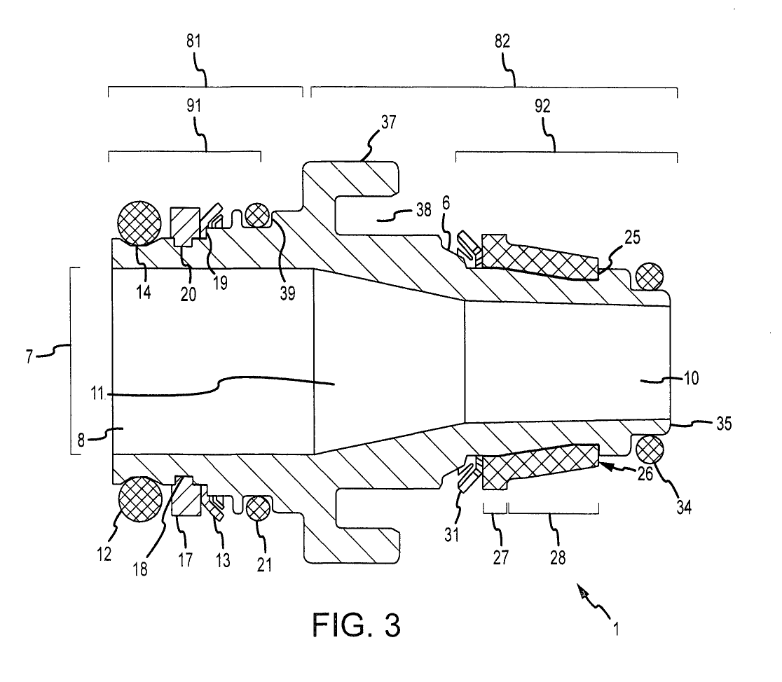

FIG. 3 shows the push-in adaptor 1 ready for use according to an embodiment of the invention. In this figure, additional components have been installed to the first and second ends 81 and 82. The first end 81 is configured to be push-in installed into a first component bore 61 of a first component 60 and the second end 82 is configured to be push-in installed into a second component bore 71 of a second component 70.

The first end 81 receives and includes a first seal 12 positioned substantially in the first groove 14. The first seal 12 and the first groove 14 can be of any predetermined shape. For example, the first groove 14 can be partially or substantially circular in shape and the first seal 12 can comprise an O-ring. However, other shapes are contemplated and are within the scope of the description and claims.

The first end 81 receives and includes a third seal 21 positioned substantially in the third groove 39. The third seal 21 and the third groove 39 can be of any predetermined shape. For example, the third groove 39 can be partially or substantially circular in shape and the third seal 21 can comprise an O-ring. Alternatively, the third groove 39 can be substantially rectangular or substantially rectangular with rounded corners, as shown. However, other shapes are contemplated and are within the scope of the description and claims.

The first end 81 receives and includes a securing element 17 in combination with a first gripping element 13. The securing element 17 in some embodiments holds the first gripping element 13 in place against the circumferential shoulder 19. The securing element 17 in some embodiments includes a tongue portion 18 that substantially engages the second groove 20. The tongue portion 18 (or the securing element 17) and the second groove 20 can be of any predetermined shape. For example, the second groove 20 can be partially or substantially rectangular in shape and the tongue portion 18 (or the securing element 17) can comprise a substantially rectangular cross-sectional seal. However, other shapes are contemplated and are within the scope of the description and claims.

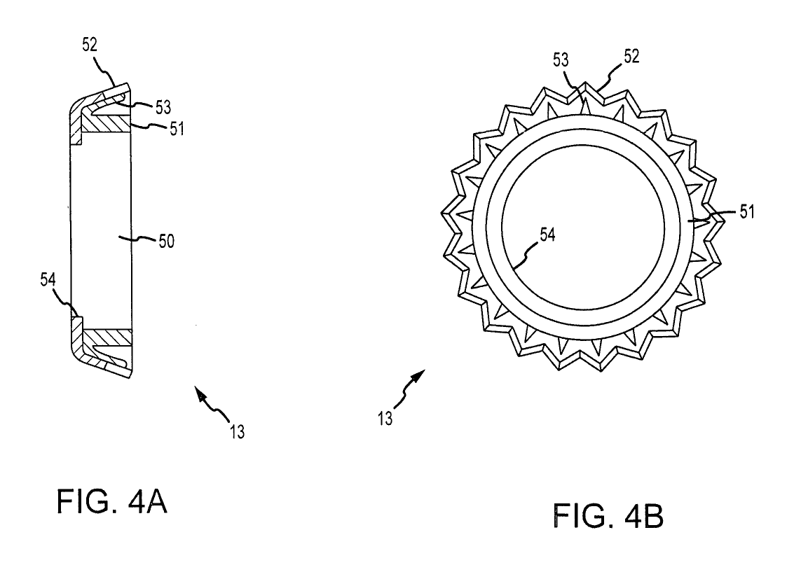

The first gripping element 13 is held substantially between the securing element 17 and the circumferential should 19 formed in the adaptor body 3. The first gripping element 13 in some embodiments is therefore immobilized on the adaptor body 3. The first gripping element 13 engages the first component bore 61 of the first component 60 (see FIG. 6) and retains the push-in adaptor 1 in the first component bore 61. It has, surprisingly, been found that the gripping and sealing elements according to the embodiments of the invention can be designed to provide a secure connection at high pressure. The first gripping element 13 is disclosed in more detail in FIGS. 4A-4B and the accompanying discussion below.

The second end 82 receives and includes a seal 34, a clip 26, and a second gripping element 31. The seal 34 is received on a reduced diameter portion 35. The reduced diameter portion 35 in some embodiments forms (or is a portion of) the circumferential shoulder 25. The circumferential shoulder 25 can prevent the seal 34 from moving farther onto the second end 82. The seal 34 can comprise any manner and shape of seal, as previously discussed.

The clip 26 is positioned on at least a portion of the substantially conical surface 24 and is located between the circumferential shoulder 25 and the step portion 6. The clip 26 is therefore substantially immobilized on the second end 82. The clip 26 engages a second component bore 71 of a second component 70.

The clip 26 includes a ring-shaped head portion 27 and a plurality of securing legs 28 extending substantially axially from the head portion 27. In some embodiments, the plurality of securing legs 28 inclines slightly toward the center or axis of the clip 26. The plurality of securing legs 28 are at least partially resilient and can flex to pass over the circumferential shoulder 25. Once in position, the plurality of securing legs 28 move resiliently inwardly and the ends of the securing legs 28 abut the circumferential shoulder 25, retaining the clip 26 on the second end 82 (see FIG. 7). The plurality of securing legs 28 therefore hold the clip 26 in position on the substantially conical surface 24. In addition, the ends of the plurality of securing legs 28 can contact a first shoulder 78 of the second component 70, preventing the push-in adaptor 1 from being pushed too far into the second component bore 71.

The head portion 27 in some embodiments contacts and abuts the second gripping element 31, wherein the head portion 27 traps the second gripping element 31 against the step portion 6. The head portion 27 extends radially outwardly past the legs 28 and functions to interact with the second component bore 71 of the second component 70. The head portion 27 of the clip 26 abuts a second shoulder 79 of the second component 70 formed in the bore 7 and is secured against it by a second gripping element 31.

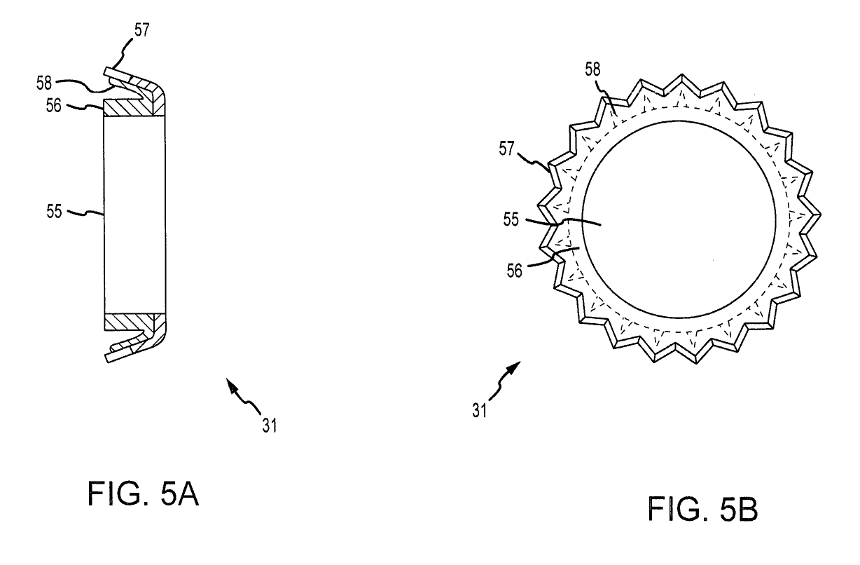

The second gripping element 31 is held substantially between the circumferential shoulder 25 and the step portion 6, wherein both the circumferential shoulder 25 and the step portion 6 can be formed in the adaptor body 3. The second gripping element 31 in some embodiments is therefore immobilized on the body 3. The second gripping element 31 engages the second component bore 71 of the second component 70 and retains the push-in adaptor 1 in the second component bore 71. It has, surprisingly, been found that the gripping and sealing elements according to the embodiments of the invention can be designed to provide a secure connection at high pressure. The second gripping element 31 is disclosed in more detail in FIGS. 5A-5B and the accompanying discussion below.

FIGS. 4A-4B show detail of the first gripping element 13 according to an embodiment of the invention. The first gripping element 13 is substantially annular in shape and fits over a portion of the first end 81 of the adaptor body 3, as previously discussed. The first gripping element 13 includes an annular member 51 including a central bore 50 and a plurality of gripping teeth 52 extending outwardly from the annular member 51. The plurality of gripping teeth 52 in some embodiments is inclined at an angle that enables insertion of the push-in adaptor 1 into the first component bore 61. The plurality of gripping teeth 52 in some embodiments is inclined at an angle that counteracts removal of the push-in adaptor 1 from the first component bore 61. However, the plurality of gripping teeth 52 can be configured to extend substantially radially outwardly in other embodiments or to extend at any predetermined angle.

The plurality of gripping teeth 52 can be substantially pointed, as shown in the figure. Alternatively, the teeth 52 can be rounded, squared off, irregular, or any other desired shape/configuration.

The plurality of gripping teeth 52 can further include ribs 53 that provide a predetermined reinforcement and stiffness to the teeth 52. The plurality of ribs 53 can extend from the annular portion. The plurality of gripping teeth 52 and the annular member 51 can be formed of the same or different material.

The plurality of gripping teeth 52 can be formed so that the material is bonded or joined to the annular portion 51. A portion of the first gripping element 13 extends past the annular portion 51 and partially radially inwardly, forming an annular extension 54 that is trapped between the securing element 17 and the circumferential shoulder 19 of the first end 81.

FIGS. 5A-5B show detail of the second gripping element 31 according to an embodiment of the invention. The second gripping element 31 is substantially annular in shape and fits over a portion of the second end 82 of the adaptor body 3, as previously discussed. The second gripping element 31 includes an annular member 56 including a central bore 55 and a plurality of gripping teeth 57 extending outwardly from the annular member 56. The plurality of gripping teeth 57 in some embodiments is inclined at an angle that enables insertion of the push-in adaptor 1 into the second component bore 71. The plurality of gripping teeth 57 in some embodiments is inclined at an angle that counteracts removal of the push-in adaptor 1 from the second component bore 71. However, the plurality of gripping teeth 57 can be configured to extend substantially radially outwardly in other embodiments or to extend at any predetermined angle.

The plurality of gripping teeth 57 can be substantially pointed, as shown in the figure. Alternatively, the teeth 57 can be rounded, squared off, irregular, or any other desired shape/configuration.

The plurality of gripping teeth 57 can further include ribs 58 that provide a predetermined reinforcement and stiffness to the teeth 57. The plurality of ribs 58 can extend from the annular portion. The plurality of gripping teeth 57 and the annular portion 56 can be formed of the same or different material.

FIG. 6 shows the push-in adaptor 1 mated to a first pneumatic or hydraulic component 60 according to an embodiment of the invention. The first component 60 can comprise any manner of pneumatic or hydraulic device, component, conduit, fitting, etc. The first component 60 includes a first component bore 61. As previously discussed, the first component bore 61 can be substantially smooth and does not require any threading, grooving, or other mechanical features in order to mate with the push-in adaptor 1. The bore 61 can be formed in cast metal and can comprise straight walls, parallel walls, or straight and parallel walls. The first component 60 does not require a threaded bore, as the adaptor 1 is securely retained by the first gripping element 13. This is achievable even at high pressures. This makes connection of the coupling device simple. Manufacturing costs are lowered, as threading is not required. This also allows for less expensive materials to be used, as the component does not have to support a thread.

In the figure, the push-in adaptor 1 has been completely mated with the first component 60. As a result, the first end 81 of the push-in adaptor 1 resides completely within the first component bore 61. It should be noted that the first component bore 61 can be deeper than the first end 81.

It can be seen from the figure that the first seal 12, the securing element 17, the first gripping element 13, and the third seal 21 are all at least partially compressed between and sealingly mated to the adaptor body 3 and the first component 60. The third seal 21 can additionally seal against the bore 61 in order to prevent the ingress of dust or dirt that may interfere with the first seal 12 and the first gripping element 13. The first gripping element 13 (and the other elements) resists and prevents removal of the first end 81 from the first component bore 61. Further, the multiple elements prevent wiggle of the push-in adaptor 1 and provide a stable mating connection, ensuring that leakage does not occur.

FIG. 7 shows the push-in adaptor 1 mated to a second pneumatic or hydraulic component 70 according to an embodiment of the invention. The second component 70 can comprise any manner of pneumatic or hydraulic device, component, conduit, fitting, etc. The second component 70 includes a second component bore 71. As previously discussed, the second component bore 71 can be substantially smooth and does not require any threading, grooving, or other mechanical features in order to mate with the push-in adaptor 1. In some embodiments, the second component bore 71 is also stepped in order to mate with the second end 82 of the push-in adaptor 1. A threaded bore is not required in the second component 70. This is achievable even at high pressures. This makes connection of the coupling device simple. Manufacturing costs are lowered, as threading is not required. This also allows for less expensive materials to be used, as the component does not have to support a thread.

In the figure, the push-in adaptor 1 has been completely mated with the second component 70. As a result, the second end 82 of the push-in adaptor 1 resides completely within the second component bore 71. It should be noted that the second component bore 71 can be deeper than the second end 82.

It can be seen from the figure that the seal 34 and the second gripping element 31 are all at least partially compressed between and sealingly mated to the adaptor body 3 and the second component 70. In addition, the clip 26 is substantially abutting a second shoulder 79 of the second component 70. The second gripping element 31 resists and prevents removal of the second end 82 from the second component bore 71. The legs 28 contact a first shoulder 78 of the second component 70 in order to prevent over-insertion.

Further, an annular component portion 76 can be received in the annular recess 38 of the collar 37. A corresponding seal 77 can provide a sealing contact between the annular component portion 76 and a portion of the annular recess 38. The seal 41 prevents the ingress of dirt or other foreign particles that could affect the integrity of the first gripping element 13 and the first seal 12. The multiple elements prevent wiggle of the push-in adaptor 1 and provide a stable mating connection, ensuring that leakage does not occur. Further, they prevent slippage or removal of the push-in adaptor 1, absent a large amount of force.

What is claimed is:

1. A push-in adaptor (1), comprising:
an adaptor body (3) including a first end (81) and a second end (82) and a bore (7) passing fully through the body (3);
a first push-in retention mechanism (91) located on the first end (81), wherein the first end (81) is adapted to push in to a first pneumatic or hydraulic component; and
a second push-in retention mechanism (92) located on the second end (82), wherein the second end (82) is adapted to push in to a second pneumatic or hydraulic component.

2. The push-in adaptor (1) of claim 1, wherein the body (3) is formed of a metallic material.

3. The push-in adaptor (1) of claim 1, wherein the body (3) is formed of a non-metallic material.

4. The push-in adaptor (1) of claim 1, wherein the body (3) is formed of a lightweight material.

5. The push-in adaptor (1) of claim 1, wherein the body (3) is formed of a plastic material.

6. The push-in adaptor (1) of claim 1, with the first push-in retention mechanism (91) further comprising:
a second groove (20) formed circumferentially on an outer surface of the adaptor body (3) at the first end (81);
a securing element (17) engaged with the second groove (20) and configured to engage an apparatus bore; and
a first gripping element (13) trapped between the securing element (17) and a circumferential shoulder (19) formed on the outer surface of the adaptor body (3), wherein the first gripping element (13) is configured to engage and retain the push-in adaptor (1) in the apparatus bore.

7. The push-in adaptor (1) of claim 1, with the first push-in retention mechanism (91) further comprising:
a first groove (14) formed circumferentially on an outer surface of the adaptor body (3) at the first end (81);
a first seal (12) configured to fit partially in the first groove (14) and adapted to sealingly contact the apparatus bore;
a third groove (39) formed circumferentially on an outer surface of the adaptor body (3) at the first end (81); and
a third seal (21) configured to fit partially in the third groove (39) and adapted to sealingly contact the apparatus bore.

8. The push-in adaptor (1) of claim 6, with the first gripping element (13) further comprising:
an annular member (51) that substantially sealingly fits to the outer surface of the adaptor body (3); and
a plurality of gripping teeth (52) extending substantially radially outwardly from the annular member (51).

9. The push-in adaptor (1) of claim 8, with the plurality of gripping teeth (52) being substantially inclined toward the annular member (51).

10. The push-in adaptor (1) of claim 1, with the second push-in retention mechanism (92) further comprising:
a substantially conical surface (24) formed on the outer surface of the adaptor body (3) at the second end (82);
a circumferential shoulder (25) located on the second end (82) adjacent to the substantially conical surface (24), wherein the circumferential shoulder (25) is configured to retain the clip (26) on the substantially conical surface (24);
a clip (26) positioned on the substantially conical surface (24), wherein the clip (26) engages the second end (82) of the adaptor body (3); and
a second gripping element (31) configured to be held between a step portion (6) of the substantially conical surface (24) and the clip (26), with the second gripping element (31) abutting a step portion (6) substantially opposite the circumferential shoulder (25) across the substantially conical surface (24).

11. The push-in adaptor (1) of claim 10, with the second gripping element (31) further comprising:
an annular member (56) that substantially sealingly fits to the outer surface of the adaptor body (3); and
a plurality of gripping teeth (57) extending substantially radially outwardly from the annular member (56).

12. The push-in adaptor (1) of claim 11, with the plurality of gripping teeth (57) being substantially inclined toward the annular member (56).

13. The push-in adaptor (1) of claim 10, with the clip (26) further comprising:
a head portion (27); and
a plurality of securing legs (28) that extends substantially axially from the head portion (27).

14. The push-in adaptor (1) of claim 10, with the second gripping element (31) further comprising a seal (34) located on a reduced diameter port (35) of the second end (82).

15. The push-in adaptor (1) of claim 10, further comprising a collar (37) including an annular recess (38), with the collar (37) being adapted to fit over and engage a seal of the second component.

16. A push-in adaptor (1) adapted for coupling a coupling device to an apparatus, the push-in adaptor (1) comprising:
an adaptor body (3) including a first end (81) and a second end (82) and a bore (7) passing fully through the body (3);
a second groove (20) formed circumferentially on an outer surface of the adaptor body (3) at the first end (81);
a securing element (17) engaged with the second groove (20) and configured to engage an apparatus bore; and
a first gripping element (13) trapped between the securing element (17) and a circumferential shoulder (19) formed on the outer surface of the adaptor body (3), wherein the first gripping element (13) is configured to engage and retain the push-in adaptor (1) in the apparatus bore.

17. The push-in adaptor (1) of claim 16, wherein the body (3) is formed of a metallic material.

18. The push-in adaptor (1) of claim 16, wherein the body (3) is formed of a non-metallic material.

19. The push-in adaptor (1) of claim 16, wherein the body (3) is formed of a lightweight material.

20. The push-in adaptor (1) of claim 16, wherein the body (3) is formed of a plastic material.

21. The push-in adaptor (1) of claim 16, further comprising:
a first groove (14) formed circumferentially on an outer surface of the adaptor body (3) at the first end (81);
a first seal (12) configured to fit partially in the first groove (14) and adapted to sealingly contact the apparatus bore;
a third groove (39) formed circumferentially on an outer surface of the adaptor body (3) at the first end (81); and
a third seal (21) configured to fit partially in the third groove (39) and adapted to sealingly contact the apparatus bore.

22. The push-in adaptor (1) of claim 16, with the first gripping element (13) further comprising:
an annular member (51) that substantially sealingly fits to the outer surface of the adaptor body (3); and
a plurality of gripping teeth (52) extending substantially radially outwardly from the annular member (51).

23. The push-in adaptor (1) of claim 22, with the plurality of gripping teeth (52) being substantially inclined toward the annular member (51).

24. A push-in adaptor (1) adapted for coupling a coupling device to an apparatus, the push-in adaptor (1) comprising:
an adaptor body (3) including a first end (81) and a second end (82) and a bore (7) passing fully through the body (3);
a substantially conical surface (24) formed on the outer surface of the adaptor body (3) at the second end (82);
a circumferential shoulder (25) located on the second end (82) adjacent to the substantially conical surface (24), wherein the circumferential shoulder (25) is configured to retain the clip (26) on the substantially conical surface (24);
a clip (26) positioned on the substantially conical surface (24), wherein the clip (26) engages the second end (82) of the adaptor body (3); and
a second gripping element (31) configured to be held between a step portion (6) of the substantially conical surface (24) and the clip (26), with the second gripping element (31) abutting a step portion (6) substantially opposite the circumferential shoulder (25) across the substantially conical surface (24).

25. The push-in adaptor (1) of claim 24, wherein the body (3) is formed of a metallic material.

26. The push-in adaptor (1) of claim 24, wherein the body (3) is formed of a non-metallic material.

27. The push-in adaptor (1) of claim 24, wherein the body (3) is formed of a lightweight material.

28. The push-in adaptor (1) of claim 24, wherein the body (3) is formed of a plastic material.

29. The push-in adaptor (1) of claim 24, with the second gripping element (31) further comprising:
an annular member (56) that substantially sealingly fits to the outer surface of the adaptor body (3); and
a plurality of gripping teeth (57) extending substantially radially outwardly from the annular member (56).

30. The push-in adaptor (1) of claim 29, with the plurality of gripping teeth (57) being substantially inclined toward the annular member (56).

31. The push-in adaptor (1) of claim 24, with the clip (26) further comprising:
a head portion (27); and
a plurality of securing legs (28) that extends substantially axially from the head portion (27).

32. The push-in adaptor (1) of claim 24, further comprising a seal (34) located on a reduced diameter port (35) of the second end (82).

33. The push-in adaptor (1) of claim 24, further comprising a collar (37) including an annular recess (38), with the collar (37) being adapted to fit over and engage a seal of the second component.
